(19) United States
(12) Patent Application Publication
(10) Pub. No.: US 2014/0226561 A1
(43) Pub. Date: Aug. 14, 2014

(54) METHOD AND APPARATUS FOR VIDEO OR MULTIMEDIA CONTENT DELIVERY

(71) Applicant: ALCATEL-LUCENT USA, INC., Murray Hill, NJ (US)

(72) Inventors: BONG HO KIM, Morganville, NJ (US); Doru Calin, Manalapan, NJ (US)

(73) Assignee: Alcatel-Lucent USA, Inc., Murray Hill, NJ (US)

(21) Appl. No.: 13/766,220

(22) Filed: Feb. 13, 2013

(51) Int. Cl. H04W 76/04

(52) U.S. Cl. CPC H04W 76/04
USPC 370/328

(57) ABSTRACT

Embodiments of the claimed subject matter provide a method and apparatus for video or multimedia content delivery. One embodiment of the method includes bypassing, at a base station, forwarding one or more packets in response to receiving one or more reset messages indicating that user equipment has terminated a communication session associated with the packet(s). The packets are received by the base station from a server.

### BACKGROUND

This application relates generally to communication systems, and, more particularly, to video or multimedia content delivery in communication systems.

Digital multimedia has become a viable and increasingly popular alternative to conventional analog transmission of video and/or audio data. For example, some estimates indicate that real-time video streaming accounted for approximately 50% of all Internet traffic in 2012. Content providers typically deliver video or multimedia content progressively by breaking up a content stream that includes a digital representation of the content into segments. The digital data is then encoded and transmitted to a client application in a receiving unit such as a television, a computer, a tablet, or a smartphone. The transmission path between the provider and the client may include wired or wireless connections and the segments of digital data are transmitted using the available bandwidth over the transmission path. For example, the client device may establish a communication session with a content provider in a network for receiving the video content.

The receiving unit typically includes one or more buffers for storing the received information for several segments before providing the encoded information to a decoder for decoding and eventual presentation of the content. If the network bandwidth available to the receiving unit is smaller than the encoded data rate of the video, playback of the video content on the client device may be delayed until sufficient content has been accumulated in the buffer so that the content can be played back without gaps or delays. The buffer may overflow if the transmitter attempts to send too much digital data to the receiving unit, resulting in data loss and possible picture drop. Conversely, the buffer may underflow if the transmitter does not send enough digital data to the receiving unit. Underflow may cause a decoder stall and the repetition of one or more images. Since overflow and underflow of the buffer may degrade user experience, conventional digital multimedia systems vary the encoding quality of each image to affect bit rate to attempt to maintain the buffer level within a selected range.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

As discussed herein, content providers attempt to control the transmission rate of video or multimedia segments to maintain a target fullness of a buffer in client devices, such as user equipment that hosts a client application. However, not all of the locally buffered data or in-flight packets of data traveling from the network to the client device are actually used for playback. For example, a user of the client device may end the communication session when the user fast forwards or rewinds the content stream, switches to a different stream, or cancels the current stream. For another example, an application in the client device may cancel the communication session, e.g., based on an algorithm that switches to a new communication session to attempt to improve throughput of the content stream.

Terminating a communication session may cause buffered or in-flight packets to be discarded without being played back. Experiments performed by the inventors indicate that as much as 10% (or possibly more in some cases) of the video content received by a typical client device may be discarded prior to being played back. Some of these experiments are discussed in Appendix A the present application. Unused video content represents wasted communication resources. For example, scarce air interface bandwidth is wasted when it is used to transmit packets of video content over the downlink (or forward link) that are later discarded prior to being played back. In addition to the wasted downlink resources, there is unnecessary uplink (or reverse link) traffic from the client (hosted by the user equipment) and control traffic accompanying the uplink traffic, which would have not occurred if there was no wasteful downlink traffic.

The disclosed subject matter is directed to addressing the effects of one or more of the problems set forth above.

In one embodiment, a method is provided for video or multimedia content delivery. One embodiment of the method includes bypassing, at a base station, forwarding one or more packets in response to receiving one or more reset messages indicating that user equipment has terminated a communication session associated with the packet(s). The packets are received by the base station from a server.

In another embodiment, an apparatus is provided for video or multimedia content delivery. The apparatus comprises a base station that is configured to bypass forwarding one or more packets in response to receiving one or more reset messages indicating that user equipment has terminated a communication session associated with the packet(s). The packets are received by the base station from a server.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a multimedia communication system;

FIG. 2 conceptually illustrates one embodiment of a segmented video or multimedia stream;

FIG. 3 conceptually illustrates one exemplary embodiment of a MAC layer that may be implemented in embodiments of the base station shown in FIG. 1;

FIG. 4 conceptually illustrates messages exchanged between user equipment (UE), a base station (BS), an image server (IMAGE), and a video content server (VCS); and

FIG. 5 conceptually illustrates messages exchanged between user equipment (UE), a base station (BS), and a video content server (VCS), according to some embodiments.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

As discussed herein, buffered or in-flight video or multimedia content may be discarded prior to being played back. Transmitting the video or multimedia content that is eventually discarded without being played back represents a waste of scarce resources, particularly uplink and downlink resources of an air interface in a wireless communication system. At least in part to reduce the waste of communication system resources, the present application describes embodiments of base stations that can be configured to detect reset messages that indicate that user equipment has terminated a communication session associated with a video or multimedia service. For example, a base station can be configured to determine a port number associated with the communication session in the reset message. The base station can then remove packets associated with the communication session from a transmit buffer so that the packets are not transmitted subsequently to the user equipment.

Some embodiments of this technique may be implemented in a communication system that delivers video or multimedia content progressively using HTTP/HTTPS protocols. The base station may therefore be configured to determine port numbers associated with a transmission control protocol (TCP) session used to provide the video or multimedia content to user equipment in a TCP-Reset message. The base station can be configured to stop transmitting packets associated with the TCP session in response to receiving the TCP-Reset message including the port number. Furthermore, the base station and user equipment can bypass transmission of other messages associated with the downlink packets that are used to carry the content that is ultimately discarded. For example, user equipment can bypass transmission of response packets to the provider and uplink resource requests, while the base station can bypass transmission of grant messages to the user equipment. Embodiments of these techniques may not be dependent on the underlying communication technologies and network protocols and consequently may be implemented at base stations without modifying the client or the media server.

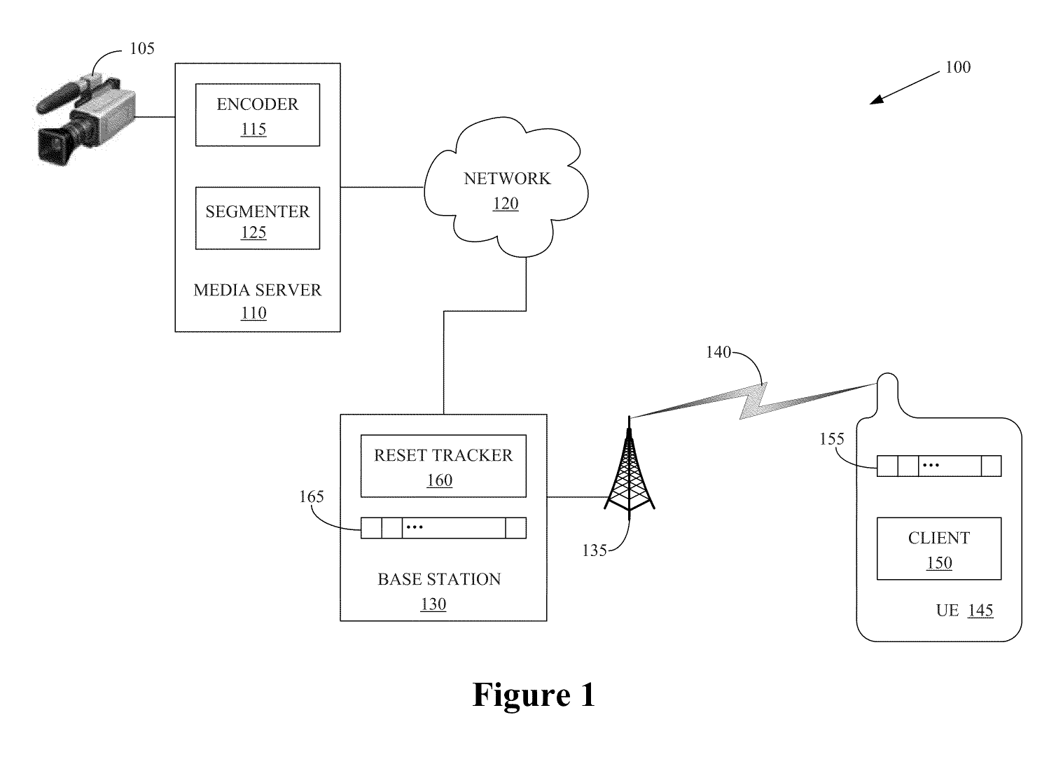

FIG. 1 conceptually illustrates one exemplary embodiment of a multimedia communication system 100. In the illustrated embodiment, the multimedia communication system includes a multimedia source device 105 that is used to generate multimedia content and provide the generated content to the multimedia communication system 100. The multimedia source device 105 may be an analog or digital video recording device (as shown in FIG. 1) or any other device capable of generating multimedia content, such as hardware, firmware, or software that is used to capture video or audio input or to create video or audio content, e.g., the device 105 may be a device for creating animations and the associated audio. In the illustrated embodiment, the multimedia content generated by the multimedia source device 105 may consist of a movie, a television program, a video-on-demand, or other content that may be viewed by a user or subscriber.

A digital representation of the multimedia content generated by the multimedia source device 105 may be provided to a media server 110 that includes an encoder 115, which may encode the digital representation for eventual transmission over a network 120 at a selected transmission or data rate. Some embodiments of the media server 110 may include a segmenter 125 that can be used to divide a video or multimedia stream into separate segments of information that, when combined, represent the original video or multimedia stream. For example, the media server 110 may provide video or multimedia content using progressive transmission as defined by the HTTP/HTTPS protocols. The media server 110 may therefore divide the video or multimedia content stream into segments that are pushed onto the network 120 at a rate that may be determined by the network bandwidth available or allocated to a subscriber.

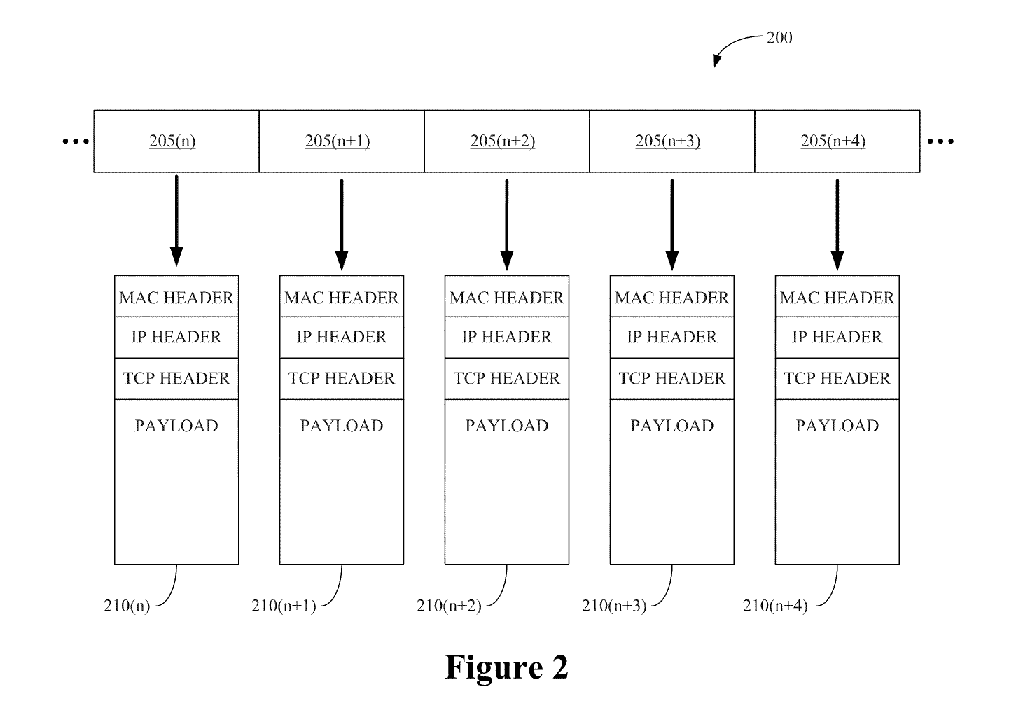

FIG. 2 conceptually illustrates one embodiment of a segmented video or multimedia stream 200. In the illustrated embodiment, the stream 200 is divided into segments 205 that include a portion of the information that can be used to render the video or multimedia content represented by the video or multimedia stream 200. The segments 205 may then be encapsulated into one or more packets 210 for subsequent transmission over the air interface. Some embodiments of the packets 210 include header information and a payload including the information used to render the video or multimedia content. The header information may include a medium access control (MAC) header, an Internet protocol (IP) header, a TCP header, or other header information.

Referring back to FIG. 1, the multimedia communication system 100 shown in FIG. 1 includes one or more base stations 130 that can be communicatively coupled to the media server 110 via the network 120. As used herein, the term “base station” will be understood to encompass any device that is capable of providing wireless connectivity to a geographic area such as a sector or cell. The term “base station” may therefore refer to devices such as access points, access nodes, base station routers, eNodeBs, home base station routers, cells, macrocells, microcells, picocells, femtocells, and the like. The base station 130 is communicatively coupled to one or more antennas 135 for transmitting or receiving communications over a downlink or uplink of an air interface 140. Techniques for implementing wireless communication over an air interface such as the air interface 140 are known in the art and in the interest of clarity only those aspects of wireless communication that are relevant to the claimed subject matter are discussed herein.

User equipment 145 may communicate with the base station 130 over the air interface 140. As used herein, the term “user equipment” may encompass mobile or portable devices such as cell phones, smart phones, tablets, ultrabooks, or laptops, as well as other wireless-enabled devices that are intended to be used in stationary locations, such as desktop computers, smart TVs, and the like. Some embodiments of the user equipment 145 implement one or more clients 150 that may be configured to receive video or multimedia content provided by the media server 110. For example, the client 150 may be used to subscribe to a video or multimedia service provided by the media server 110. Video or multimedia content received from the media server 110 may be played back using features of the user equipment 145 such as displays, screens, touchscreens, speakers, or other elements that can generate or simulate tactile sensations.

In the illustrated embodiment, the media server 110 provides the encoded content to the user equipment 145 via a network 120 and the base station 130. For example, a communication session such as a transmission control protocol (TCP) session may be established for the media server 110, the base station 130, and the user equipment 145. The TCP session may then be used to transmit packets including encoded portions of the segmented video or multimedia stream that has been requested by the client 150. Some embodiments of user equipment 145 include a buffer 155 that can be used to store the received packet before reading out the data and using it to render the video or multimedia content. Some embodiments of the encoder 115 may use models of the buffer 155 to decide how to encode the data stream, e.g., to select the bit rate that is used to encode the data streams received from the multimedia source device 105. Techniques for modeling or encoding data streams provided to decoder buffers are known in the art and in the interest of clarity only those aspects of modeling or encoding the data streams that are relevant to the claimed subject matter are discussed herein.

As discussed herein, in many instances, a significant percentage of the packets that are delivered to user equipment 145 over the air interface 140 as part of a video or multimedia stream may not be used to render the video or multimedia content at the user equipment 145. The packets may be discarded and therefore represent a waste of scarce air interface resources. Furthermore, some embodiments of user equipment 145 may be configured to acknowledge reception of packets received from the media server 110 through the base station 130. Messages exchanged as part of the acknowledgment process for packets that are not used to render content represent an additional waste of scarce air interface resources. For example, the base station 130 and the user equipment 145 may exchange response packets, uplink resource requests, or resource grant messages during the acknowledgment process. The base stations 130 may therefore be configured to bypass transmission of packets received from the media server 110 over the downlink of the air interface 140 in response to determining that the user equipment 145 is no longer accepting packets associated with the communication session.

Some embodiments of the base station 130 include a reset tracker 160 that can be used to detect reset messages transmitted over the uplink of the air interface 140 by user equipment 145. For example, user equipment 145 may transmit a TCP reset message indicating that user equipment 145 is no longer accepting packets associated with a TCP session and may therefore be terminating the TCP session. The TCP reset message includes a port number that identifies the TCP session and the reset tracker 160 can use this port number to identify the terminated session. The reset tracker 160 may use this information to identify packets that are associated with the terminated session and are received from the media server 110. The reset tracker 160 may then cause transmission of these packets to user equipment 145 to be bypassed in response to determining that they are associated with a terminated session. For example, the reset tracker 160 may cause a transmission buffer 165 to discard packets associated with the terminated session so they are not transmitted over the downlink.

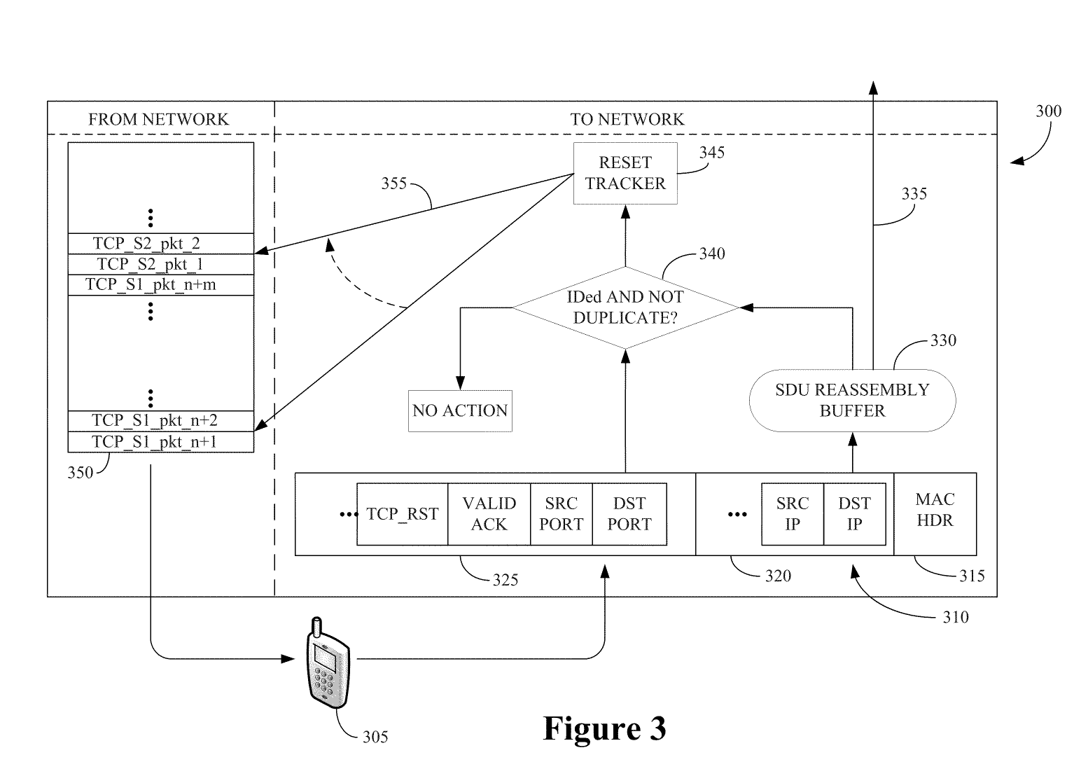

FIG. 3 conceptually illustrates one exemplary embodiment of a MAC layer 300 that may be implemented in embodiments of the base station 130 shown in FIG. 1. The left-hand side of the MAC layer 300 depicts a portion of the MAC layer 300 that is part of the downlink path from the network to user equipment 305. The right-hand side of the MAC layer 300 depicts a portion of the MAC layer 300 that is part of the uplink path from user equipment 305 to the network. The MAC layer 300 shown in FIG. 3 has received a packet 310 from user equipment 305 over the uplink of an air interface. The packet 310 includes a MAC header 315, an IP header 320, and a TCP header 325. The IP header 320 includes fields for information indicating a source IP address (SRC IP) and a destination IP address (DST IP), as well as other information. The TCP header 325 includes fields for information including a source port (SRC PORT), a destination port (DST PORT), valid/acknowledgment field (VALID ACK) and a field (TCP_RST) indicating whether the packet 310 is a TCP reset message.

Information extracted from the packet 310 may be provided to a service data unit (SDU) reassembly buffer 330 that is implemented in the MAC layer 300. The SDU reassembly buffer 330 may be used to hold information that is part of a packet that has been segmented prior to transmission over the uplink. The reassembled SDU may then be provided to the network, as indicated by the arrow 335. The MAC layer 300 also includes logic 340 that can be used to identify a communication session such as a TCP session associated with the packet 310. The illustrated embodiment of the logic 340 uses information from the packet 310 or the reassembly buffer 330 to identify the communication session. For example, the logic 340 may use the source and destination ports of the packet 310 to identify the TCP session associated with the packet 310. The logic 340 may also use this information to determine whether information in the packet 310 is duplicated by a previously received packet, e.g., information stored in the reassembly buffer 330. If the logic 340 is not able to identify a TCP session associated with the packet 310, or if the logic 340 determines that the TCP information associated with the packet 310 has already been used to identify a TCP session using information from a previously received packet, the MAC layer 300 may not take any action. If the logic 340 identifies a non-duplicate TCP session associated with the packet 310, a signal may be provided to a reset tracker 345.

The reset tracker 345 depicted in FIG. 3 is configured to detect packets associated with the TCP session identified by the logic 340. Reception of a packet that includes a reset message for the TCP session indicates that user equipment 305 is no longer accepting packets for this TCP session and may have terminated the TCP session. Some embodiments of the reset tracker 345 may therefore be used to search a downlink transmission buffer 350 to identify packets associated with the TCP session and then cause the downlink transmission buffer 350 to discard these packets. For example, if the logic 345 has identified a non-duplicate TCP session (S1) in the reset message 310, packets associated with the TCP session 51 may be discarded from the downlink transmission buffer 350. The reset tracker 345 may therefore modify a pointer 355 so that it points to packets associated with the TCP session S2 (e.g., TCP_S2_pkt_{—}1, TCP_S2_pkt_{—}2, etc.) instead of packets associated with the TCP session S1 (e.g., TCP_S1_pkt_n+1, TCP_S1_pkt_n+2, . . . , TCP_S1_pkt_n+m), thereby causing the downlink transmission buffer 350 to discard the packets associated with the TCP session 51. Transmission of these packets is therefore bypassed by the MAC layer 300.

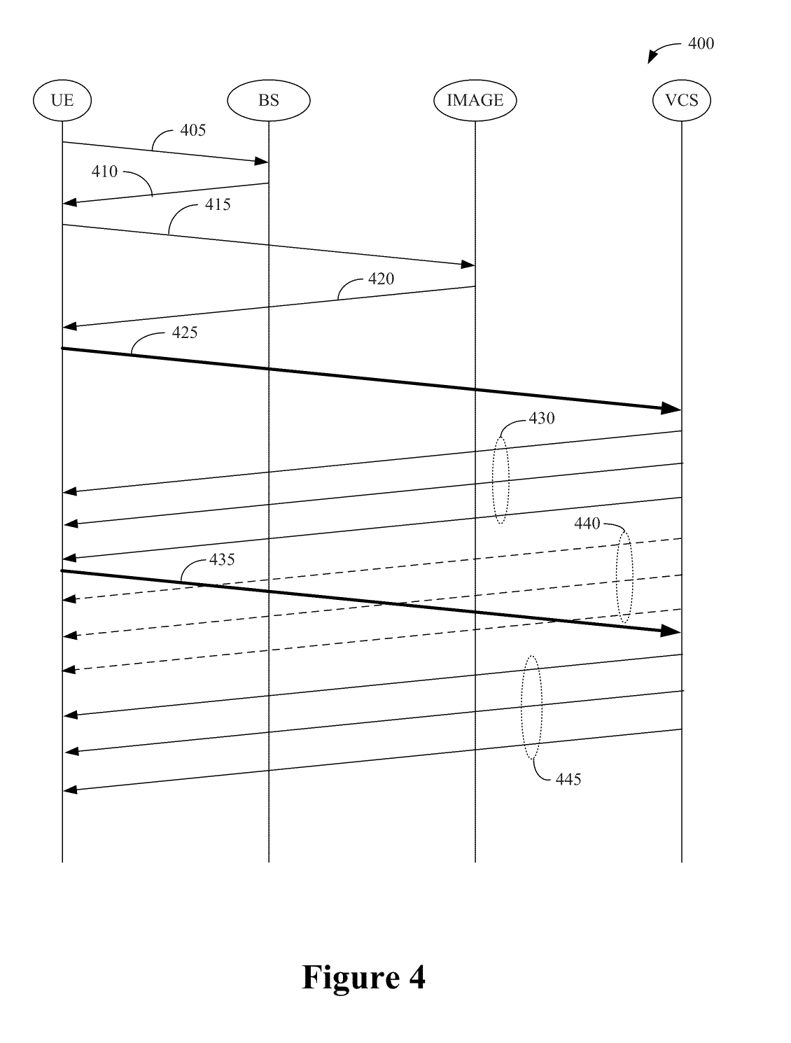

FIG. 4 conceptually illustrates messages exchanged between user equipment (UE), a base station (BS), an image server (IMAGE), and a video content server (VCS). In the illustrated embodiment, video content is delivered progressively according to HTTP/HTTPS protocols using a TCP session. A client in the UE sends an HTTP GET message in the packet flow 405 to connect to a video streaming service provider (not shown in FIG. 4) via the base station (BS). For example, the HTTP GET message may include a text/html file that includes a unique identifier of the requested video, user-agent information such as the operating system and application types running on the device, and cookie information such as information indicating a recently watched video list that may be stored on the UE. Then, the video streaming service provider responds (at 410) back to the UE (via the BS) with a list of the Content Distribution Network (CDN) servers that contain the video file and image servers that contain downloadable background images associated with the video streaming service. The UE transmits one or more HTTP GET messages (at 415) to the IMAGE server concurrently with downloading (at 420) background images from the IMAGE server. Exemplary images may include Web-page images, thumbnails, or snap shots of the requested video.

The UE (or a client implemented on the UE) initiates the video streaming service by transmitting (at 425) an HTTP GET message that may include a port number to identify the TCP session. For example, when a subscriber clicks the play button for a video streaming application implemented in the UE, the UE may start downloading the video data from one of the CDN servers by sending (at 425) an HTTP GET message with the TCP port number 5000. Some embodiments of the HTTP GET message may be used to request substantially all of the video streaming information in a single request. The VCS may then begin transmitting packets including the segmented content to the UE (at 430). However, the UE may subsequently terminate the TCP session and establish another TCP session before the VCS has completed transmitting the segmented packets for the requested video service. For example, the UE may initiate a new TCP session associated with port 5001 by transmitting (at 435) an HTTP GET message. The new TCP session may be requested (at 435) to start a new video streaming service, to improve throughput of the existing video streaming service, to move to another point in the video streaming service, or for other reasons.

The client may discard content in packets that are delivered to the UE after the UE requests a new communication session or stops accepting packets delivered using the previous communication session, e.g., following transmission (at 435) of the HTTP GET message to establish the new TCP session. For example, the VCS may continue to transmit packets (at 440) towards the UE because it is not aware that the UE has requested the new session or has stopped accepting packets associated with the old session. Each transmission 440 that is rejected by the UE may also generate one or more additional messages such as a reset message, an uplink request message for bandwidth to transmit the reset message, and an uplink grant message to grant the request for bandwidth to transmit the reset message. The number of rejected transmissions 440 and corresponding response messages may depend on the latency between terminating the old communication session and establishing the new communication session. The latency between transmission (at 435) of the HTTP GET message, establishment of the new communication session at the VCS, and termination of the old communication session at the VCS may be due to signal travel times, processing times in the BS, IMAGE server, or VCS, or other delays.

Once the new communication session has been established between the UE and VCS, the VCS may begin transmitting (at 445) packets including content associated with the video or multimedia streaming service towards the UE using the new communication session. The UE or client may begin accepting these packets and using them to render video or multimedia content.

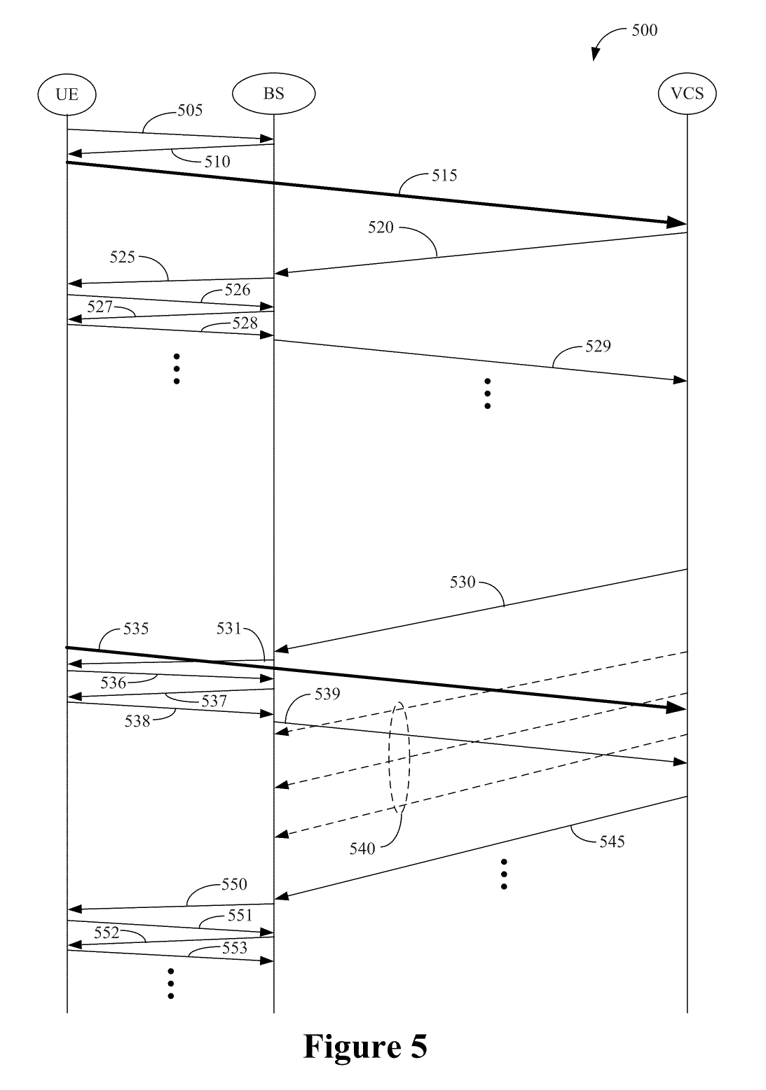

FIG. 5 conceptually illustrates messages exchanged between user equipment (UE), a base station (BS), and a video content server (VCS), according to some embodiments. Some embodiments of the UE may be implemented as the UE 145 shown in FIG. 1, some embodiments of the BS may be implemented as the base station 130 shown in FIG. 1, and some embodiments of the VCS may be implemented as the media server 110 shown in FIG. 1. In the illustrated embodiment, video content is delivered progressively according to HTTP/HTTPS protocols using a TCP session. A client in the UE sends an HTTP GET message in the packet flow 505 to connect to a video streaming service provider (not shown in FIG. 5) via the base station (BS). Then, as discussed herein, the BS responds (at 510) with a list of the CDN servers that contain the video file and image servers that contain downloadable background images associated with the video streaming service. The UE may download background images from an image server, as discussed herein. Exemplary images may include Web-page images, thumbnails, or snap shots of the requested video.

The UE (or a client implemented on the UE) initiates the video streaming service by transmitting (at 515) a HTTP GET message that may include a port number to identify the TCP session. For example, when a subscriber clicks the play button for a video streaming application implemented in the UE, the UE may start downloading the video data from one of the CDN servers by sending (at 515) an HTTP GET message with the TCP port number 5000. Some embodiments of the HTTP GET message may be used to request substantially all of the video streaming information in a single request. The VCS may then begin transmitting packets including the segmented content to the UE (at 520) to the BS for transmission (at 525) over the air interface between the BS and the UE. The UE may then begin an acknowledgment process by transmitting (at 526) a message requesting bandwidth from the BS to transmit an acknowledgment over the uplink. The BS may respond (at 527) with a message granting the requested bandwidth and then the UE may transmit (at 528) an acknowledgment of the received packet, e.g., an ACK/NACK signal depending on whether the packet was successfully decoded. The BS may then transmit (at 529) an acknowledgment signal to the VCS.

The VCS may continue transmitting packets including the segmented content to the UE (at 530) to the BS for transmission (at 531) over the air interface between the BS and the UE. However, in the illustrated embodiment, the UE decided to terminate the TCP session and establish another TCP session at some point prior to receiving the transmission 531. For example, the UE may initiate a new TCP session associated with port 5001 by transmitting (at 535) an HTTP GET message. The UE may therefore reject or discard the received packet and may notify the VCS that it has rejected or discarded the packet. For example, the UE may begin a reset process by transmitting (at 536) a message requesting bandwidth from the BS to transmit a reset message over the uplink. The BS may respond (at 537) with a message granting the requested bandwidth and then the UE may transmit (at 538) a reset message indicating that the UE has rejected or discarded the packet associated with the previous communication session. The BS may then transmit (at 539) a reset message to the VCS.

The BS may also be configured to detect the reset message 538 and use this message to bypass transmission of packets associated with the terminated TCP session over the air interface. Some embodiments of the BS may implement a MAC layer such as the MAC layer 300 depicted in FIG. 3 to track reset messages 538 and use the tracking results to bypass packet transmission associated with terminated sessions. For example, the BS may be configured to discard previously received or buffered packets that are associated with the terminated TCP session. The BS may also discard packets received in subsequent transmissions (e.g., the dashed lines indicated by the reference numeral 540) from the VCS using the terminated TCP session. Bypassing transmission of the packets over the air interface saves resources that would have been used for this transmission, as well as resources used for subsequent acknowledgment or reset messages. For example, bypassing transmission would conserve the resources corresponding to the messages 536, 537, 538, 539 that are triggered by reception of the packet 531.

Following reception of the HTTP GET message (at 535) or the reset message (at 539), the VCS can tear down the previous TCP session (e.g., the TCP session associated with the port 5000) and establish the new TCP session (e.g., the TCP session associated with the port 5001). The VCS may then begin transmitting (at 545) packets towards the BS using the new TCP session. Since the BS can determine that the packets are not associated with the terminated previous TCP session, the BS forwards (at 550) the packets over the air interface towards the UE. The UE may then begin an acknowledgment process by transmitting (at 551) a bandwidth request message to the BS, which may respond (at 552) with a grant message. The UE may then transmit (at 553) and acknowledgment of the received packet, e.g., an ACK/NACK signal depending on whether the packet was successfully decoded.

The present application describes embodiments of a simple, yet robust mechanism to reduce or eliminate wasteful content delivery traffic by bypassing transmission of unnecessary packets over the air interface. Some embodiments of the techniques described herein may result in a bandwidth saving of 10% or higher, depending on the circumstances, of the video or multimedia traffic over the air interface. This estimate is based on current estimates of the mobile video traffic usage. Embodiments of the mechanism described herein may be implemented at the base station and not in user equipment. Thus, the benefits of these embodiments may be achieved without affecting the existing TCP or application layer. The air interface bandwidth saving could reduce the monthly data usage for mobile subscribers. Embodiments of these techniques may also be compatible with applications which use the TCP protocol, not only for video or multimedia applications.

Some embodiments of the techniques described herein may have a number of advantages over the conventional practice. For example, embodiments of the techniques described herein do not manipulate the HTTP connection originated from the client and do not generate new messages to clients and servers in order to deal with the data. Thus, this approach does not generate an interruption in the end-to-end connections between clients and servers. Embodiments of the techniques described herein may also improve the efficiency of bandwidth usage on air interface for both downlink and uplink by discarding the wasteful traffic from the server to the mobile station, as well as reducing or eliminating the TCP RST packets that would have been sent by the mobile station to the server (uplink to downlink) had the wasteful packet been delivered to the mobile station (downlink to uplink). The reduction or elimination of unnecessary uplink packets may also reduce or eliminate unnecessary control message exchange with the base station associated with transmitting the unnecessary uplink packets.

Embodiments of the techniques described herein may be implemented without affecting the behavior of applications used for transmitting or receiving video or multimedia content. For example, the application does not send any TCP RST message for downloaded content unless it receives video content from a closed or terminated TCP connection. Consequently, the number of TCP RST messages is expected to be significantly reduced. Embodiments of these techniques may also be integrated in existing base stations without disruption, since some embodiments may be implemented as an independent module with little interaction with the other modules. For example, some embodiments of the module may mirror the TCP information from the received packet before and after the reassembly buffer at the base station. Furthermore, embodiments of these techniques should not affect performance since the enhancement module does not hold any part of the packet flows in the system.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
bypassing, at a base station, forwarding at least one packet in response to receiving at least one reset message indicating that user equipment has terminated a communication session associated with said at least one packet, wherein said at least one packet is received by the base station from a server.

2. The method of claim 1, wherein said at least one packet comprises information associated with a video or multimedia service provided to said user equipment by the server.

3. The method of claim 1, wherein the communication session is a transmission control protocol (TCP) session established for said user equipment and the server, and wherein bypassing forwarding said at least one packet comprises bypassing forwarding said at least one packet in response to the base station detecting at least one TCP reset message from said user equipment.

4. The method of claim 1, comprising detecting said at least one reset message associated with the communication session based on at least one port number indicated in said at least one reset message, wherein said at least one port number is associated with the communication session.

5. The method of claim 4, wherein detecting said at least one reset message comprises determining that said at least one port number associated with the communication session is not the same as at least one previously received port number indicated by at least one previously received reset message.

6. The method of claim 1, wherein bypassing forwarding of said at least one packet comprises bypassing forwarding of at least one packet stored in a transmission buffer by the base station.

7. The method of claim 6, wherein bypassing forwarding of said at least one packet stored in the transmission buffer comprises modifying a value of a pointer into the transmission buffer so that said at least one packet is not forwarded.

8. The method of claim 6, comprising discarding said at least one packet stored in the transmission buffer.

9. The method of claim 1, wherein bypassing forwarding of said at least one packet comprises receiving said at least one packet after receiving said at least one reset message and bypassing forwarding of said at least one received packet after receiving said at least one reset message.

10. A base station configured to bypass forwarding at least one packet in response to receiving at least one reset message indicating that user equipment has terminated a communication session associated with said at least one packet, wherein said at least one packet is received by the base station from a server.

11. The base station of claim 10, wherein said at least one packet comprises information associated with a video or multimedia service provided to said user equipment by the server.

12. The base station of claim 10, wherein the communication session is a transmission control protocol (TCP) session established for said user equipment and the server, and wherein the base station is configured to bypass forwarding said at least one packet in response to detecting at least one TCP reset message from said user equipment.

13. The base station of claim 10, comprising a medium access control (MAC) layer configured to detect said at least one reset message associated with the communication session based on at least one port number indicated in said at least one reset message, wherein said at least one port number is associated with the communication session.

14. The base station of claim 13, wherein the MAC layer is configured to determine that said at least one port number associated with the communication session is not the same as at least one previously received port number associated with at least one previously received reset message.

15. The base station of claim 10, comprising a transmission buffer for holding packets prior to transmission and tracking logic configured to identify said at least one packet in the transmission buffer and cause the base station to bypass forwarding of said at least one packet.

16. The base station of claim 15, wherein the tracking logic is configured to cause the base station to bypass forwarding of said at least one packet by modifying a value of a pointer into the transmission buffer so that said at least one packet is not forwarded.

17. The base station of claim 15, wherein the tracking logic is configured to cause the base station to bypass forwarding of said at least one packet by causing the transmission buffer to discard said at least one packet stored in the transmission buffer.

18. The base station of claim 10, wherein the base station is configured to receive said at least one packet after receiving said at least one reset message and bypass forwarding of said at least one received packet after receiving said at least one reset message.
